(19) United States
(12) Patent Application Publication
(10) Pub. No.: US 2014/0104622 A1
(43) Pub. Date: Apr. 17, 2014

(54) SYSTEM FOR OBTAINING THE SHAPE OF MOTOR VEHICLES

(71) Applicant: OMG DI GEMINIANI GINO, Communanza AP (IT)

(72) Inventor: Gino Geminiani, Comunanza AP (IT)

(21) Appl. No.: 14/118,663

(22) PCT Filed: May 18, 2012
(86) PCT No.: PCT/IT2012/000147

§ 371 Date: Nov. 19, 2013

(30) Foreign Application Priority Data
May 20, 2011 (IT) AN2011A000063

(51) Int. Cl. B60S 3/04

(52) U.S. Cl. CPC B60S 3/04
USPC 356/612

(57) ABSTRACT

A system for obtaining the external shape of motor vehicles can be applied to car-washing apparatuses. The system is able to reproduce the external shape of motor vehicles. The system has means for detecting the outer shape of a motor vehicle, a central operating control unit, and software means for handling and processing data loaded on the central operating control unit.

The present invention relates to a system for obtaining the shape of motor vehicles which can be applied to automatic or semi-automatic car-washing apparatuses.

Since car-washing apparatuses tend to be increasingly used during the last years, there is a need for systems adapted for obtaining the shape of motor vehicles which can be applied to said car-washing apparatuses in order to obtain the shape of the motor vehicle to be washed in a quick and accurate manner.

In fact, given the large number of types of motor vehicles currently available to drivers, it is difficult to store all the shapes of the various types of motor vehicles available on the market and circulating through the streets in the processor, without forgetting the need to update said storage with the new types of motor vehicles which are periodically launched by the manufacturers of motor vehicles.

Currently, the state of the art provides systems for acquiring the shape of motor vehicles for car-washing apparatuses which can be applied to car-washing apparatuses adapted for controlling the washing means based on the shape previously obtained from the motor vehicle.

Thus, these systems can be poorly applied to and used with car-washing apparatuses which are already installed and working.

In addition, these acquisition systems have problems in recognizing and identifying the entire shape of the motor vehicle located inside the washing zone due to the glass surfaces of the motor vehicle.

Accordingly, an aim of the present invention is to provide a system for obtaining the external shape of motor vehicles which can be applied to automatic or semi-automatic car-washing apparatuses already installed or to be installed and which can be used under every ambient light condition as well as under every weather condition, said system comprising at least one sensor means, means for handling and processing data, and a central operating control unit.

A further aim of the present invention is to provide a system for obtaining the external shape of motor vehicles which can recognize and identify the entire shape of the motor vehicle, including the glass surfaces thereof, in order to reconstruct the shape of the motor vehicle.

An aim of the present invention is a method which allows the data obtained by the above-mentioned system to be optimally handled and processed.

Therefore, an object of the present invention is a system for obtaining the external shape of motor vehicles which can be applied to car-washing apparatuses already installed or to be installed, said system being able to reproduce the external shape of said motor vehicles and comprising means for detecting the outer shape of the motor vehicle, a central operating control unit, and software means for handling and processing data loaded on said central unit.

A further object of the invention is a method for obtaining, handling and processing data in an automatic or semi-automatic car-washing apparatus, comprising the following operative steps:
a) receiving and handling all the data obtained by the sensor means while reading the shape of the motor vehicle;
b) once said motor vehicle has been three- dimensionally scanned, filtering the collected data in order to eliminate any false positive, namely those points which have been obtained but do not correspond to the shape of said motor vehicle;
c) once the data filtering step has been completed and the shape of the imaged motor vehicle has been obtained, processing the paths to be followed by the movable washing means during the washing step of the motor vehicle.

These and other features of the invention, and the advantages derived therefrom, will become apparent from the following detailed description of a preferred embodiment thereof given by way of a non-limiting example with reference to the accompanying drawings, in which:

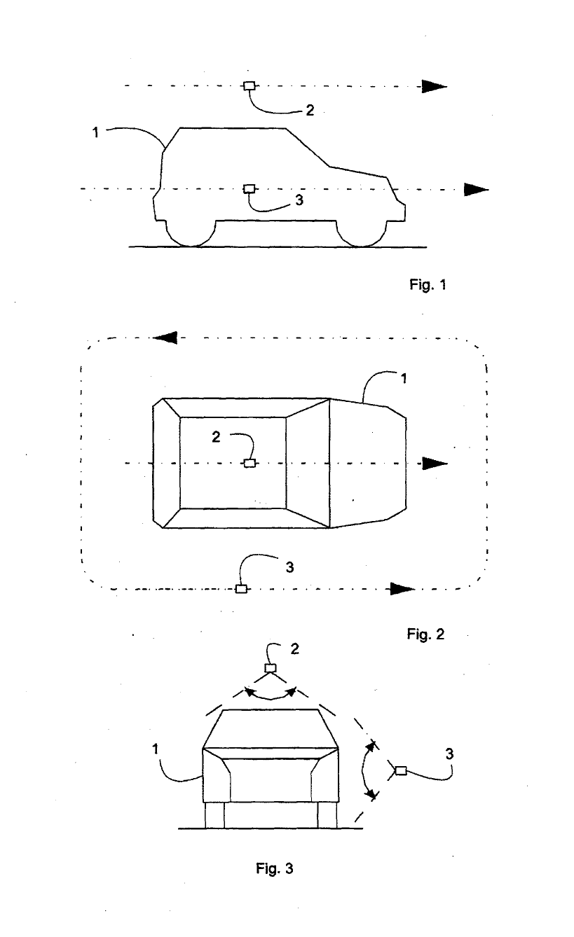

FIG. 1 is a side view of the motor vehicle located in the dedicated washing area inside the car-washing apparatus;

FIG. 2 is a top view of the motor vehicle located in the dedicated washing area inside the car-washing apparatus;

FIG. 3 is a front view of the motor vehicle located in the dedicated washing area inside the car-washing apparatus;

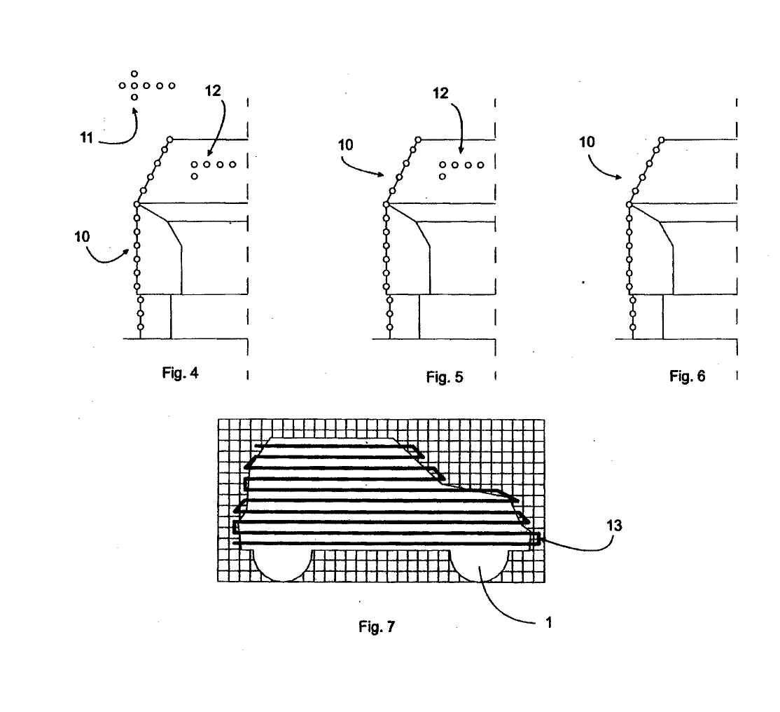

FIG. 4 is a view of the motor vehicle as scanned by the system for obtaining the external shape of motor vehicles according to the present invention;

FIG. 5 is a view of the motor vehicle as scanned when a filter for removing the points external to the shape has been applied;

FIG. 6 is a view of the motor vehicle as scanned when a filter for removing the points internal to the shape has been applied;

FIG. 7 is a side view of the shape of the motor vehicle with the paths followed by the movable washing means during the washing step.

In FIG. 1 there is shown a side view of the motor vehicle 1 located in the dedicated washing area inside the car-washing apparatus.

As seen in the Figure, there are sensor means 2 and 3, where the top sensor means 2 takes a reading of the motor vehicle 1 from the top thereof and is moved along the direction indicated by the arrow, while the side sensor means 3 takes a reading of said motor vehicle from the side thereof and is also moved along the direction indicated by the arrow.

The top sensor means 2 and the side sensor means 3 are secured to the structure of the car-washing apparatus and mounted on guide means which allow said sensor means to be moved along the respective operative directions; particularly, the top sensor means 2 takes a reading of the motor vehicle 1 from the top thereof and is movable with respect to the longitudinal axis of said motor vehicle 1, while the side sensor means 3 takes a reading of the motor vehicle 1 from the side thereof and is movable around the side surface of said motor vehicle 1.

Said sensor means 2 and 3 substantially include laser beams which are projected onto the motor vehicle 1; said laser beams are impinged onto and reflected by the surface of the motor vehicle 1, and the distance of a given point of the motor vehicle 1, namely the point which caused the reflection of said laser beam, from the sensor means which emitted the laser beam can be determined by calculating the time elapsing between the emission time of the laser beam and the reception time of the reflected pulse.

FIG. 2 is a top view of the motor vehicle located inside the car-washing apparatus.

Assuming that like elements are referred to by like reference numerals, from FIG. 2 it can be inferred that the top sensor means 2 is moved from the rear part to the front part of the motor vehicle 1, while the sensor means 3 is moved along the perimeter of said motor vehicle 1 in order to obtain points of said perimeter.

FIG. 3 is a front view of the motor vehicle located in the dedicated washing area inside the car-washing apparatus.

The Figure shows that the sensor means 2 and 3 are allowed to swing with respect to the lying plane thereof; said swinging movement covers an angle of 190°, thus allowing all the data of the motor vehicle 1 to be captured.

FIG. 4 is a view of the motor vehicle as scanned by the system for obtaining the external shape of motor vehicles according to the present invention.

As can be seen from FIG. 4, not all the points so obtained correspond to the shape of the motor vehicle 1, due to the occurrence of false positives during the step of obtaining the data.

These false positives can be substantially divided into two categories: false positives 11 from points external to the motor vehicle 1, and false positives 12 from points internal to the motor vehicle 1.

False positives 11 are predominant in number and easy to be identified and eliminated during the data filtering step, while the false positives 12 correspond to the glass parts of the motor vehicle 1 which have a poor reflecting power with respect to the laser beam, which thus is passed through these glasses and reflected by the internal parts of the motor vehicle 1.

During the filtering step, the points which are separated from the sensor means by more than a certain distance are first discarded; this can eliminate the false positives 11 and some false positives 12 which are too far from said shape.

FIG. 5 is a view of the motor vehicle as scanned when a filter for removing the points external to the shape has been applied.

Once the false positives 11 has been eliminated, a mathematical filter is applied which allows the points identifying the correct shape of said motor vehicle 1 to be obtained.

This mathematical filter includes a data processing operation based on a mathematical function called “spline”.

Said mathematical function comprises a set of polynomials connected to each other with the purpose of interpolating a set of points—called nodes of the spline—over a given range, in such a way that the function is continuous at each point of the range up to at least a given order of derivatives.

Said spline is substantially a numerical analysis tool used for interpolation, and it is obtained by dividing the range into more sub-ranges (Ik=[xk,xk+1] where k=1, . . . , N−1) and selecting a polynomial of degree n (usually a small degree) for each sub-range; thereafter, two successive polynomials are set to be smoothly fitted to each other, that is, in such a way that the first derivatives are continuous. The result of this operation is a shape corresponding to the effective shape of the motor vehicle 1 with an increased accuracy.

FIG. 6 is a view of the motor vehicle as scanned when a filter for removing the points internal to the shape has been applied.

As seen in the Figure, the final shape as defined by points 10 is obtained by applying certain data- selection criteria and filters to the resulting data in order to eliminate any false positives.

FIG. 7 is a side view of the shape of the motor vehicle with the paths followed by the movable washing means during the washing step.

Once the data filtering step has been completed and the shape of the motor vehicle as shown in FIG. 6 has been obtained, the path 13 to be followed by the is movable washing means during the washing step of the motor vehicle 1 is determined.

In this calculation step, each surface of the motor vehicle 1 is divided into sectors equal in size and shape to each other, and a spline-based mathematical operation is performed on each sector to determine a central point for each sector.

The path 13 to be followed by the movable washing means can be established with the use of said central points.

FIG. 8 shows the block diagram identifying the operative algorithm of the software for handling and processing data according to the present invention.

The software receives and handles all the data obtained by the sensor means while reading the shape of the motor vehicle.

Once said motor vehicle has been three- dimensionally scanned, the software filters the collected data in order to eliminate any false positive, namely those points which have been obtained but do not correspond to the shape of said motor vehicle.

These false positives can be substantially divided into two categories: false positives from points external to the motor vehicle, and false positives from points internal to said motor vehicle.

False positives originating from points external to the motor vehicle are predominant in number and easy to be identified and eliminated during the data filtering step.

In fact, the software discards the points which are separated from the sensor means by more than a certain distance; this allows to eliminate the false positives 11 originating from points external to the motor vehicle.

False positives originating from points internal to the motor vehicle correspond to the glass parts of said motor vehicle 1 which have a poor reflecting power with respect to the laser beam, which thus is passed through said glasses and reflected by the internal parts of the motor vehicle 1.

Some of the false positives originating from points internal to the motor vehicle are discarded by the software since they are separated from the sensor means by more than a certain distance.

After this initial filtering step, the software uses a mathematical filter which can determine the points identifying the correct shape of said motor vehicle.

Said mathematical filter includes a data processing operation based on the mathematical function called “spline”.

Said mathematical function comprises a set of polynomials connected to each other with the purpose of interpolating a set of points—called nodes of the spline—over a given range, in such a way that the function is continuous at each point of the range up to at least a given order of derivatives.

Once the false positives have been eliminated, the software proceeds with the processing of the data, which allows the shape of the motor vehicle and the paths to be followed by the movable washing means during the washing step to be determined.

Once the data filtering step has been completed and the shape of the imaged motor vehicle has been obtained, the software processes the paths to be followed by the washing means during the washing step of the motor vehicle.

In this calculation step, each surface of the motor vehicle is divided into sectors equal in size and shape to each other, and a spline-based mathematical operation is performed on each sector to determine a central point for each sector.

The path 13 to be followed by the washing means can be established with the use of said central points.

1. A system for obtaining an external shape of motor vehicles, said system being applicable to car-washing apparatuses already installed or to be installed, said system being able to reproduce the external shape of said motor vehicles and comprising:
means for detecting an outer shape of the motor vehicle,
a central operating control unit, and
software means for handling and processing data loaded on said central operating control unit.

2. The system according to claim 1, wherein said means for detecting comprise distance detection laser sensor means and are slidably arranged on guide means which are attached to a support structure of the car-washing apparatus.

3. The system according to claim 2, wherein said means for detecting comprises:
a top sensor means taking a reading of the motor vehicle from a top of the motor vehicle, said top sensor means being movable with respect to a longitudinal axis of said motor vehicle; and
a side sensor means taking a reading of the motor vehicle from a side of the motor vehicle, said side sensor means being movable around a side surface of said motor vehicle.

4. The system according to claim 3, wherein said top and side sensor means can swing with respect to a given plane by an angle of about 190° to allow all the data of the shape of the motor vehicle to be obtained.

5. The system according to claim 2, wherein laser beams emitted by each sensor means are impinged onto the surface of the motor vehicle and reflected by said surface; a distance of a given point of the motor vehicle, namely a point which caused a reflection of said laser beam, from the sensor means which emitted the laser beam is determined by calculating a time elapsing between an emission time of the laser beam and a reception time of a reflected pulse.

6. A method for obtaining, handling and processing data in an automatic or semi-automatic car-washing apparatus provided with movable washing means, comprising:
receiving and handling all data obtained by sensor means while reading a shape of a motor vehicle;
filtering, once said motor vehicle has been three-dimensionally scanned, the data in order to eliminate false positives, wherein the false positives correspond to points of data which have been obtained but do not correspond to the shape of said motor vehicle; and
processing, once the filtering has been completed and the shape of the motor vehicle has been obtained, paths to be followed by the movable washing means during a washing step of the motor vehicle.

7. The method according to claim 6, wherein said false positives are divided into:
false positives from points external to the motor vehicle, and
false positives from points internal to said motor vehicle.

8. The method according to claim 6, wherein the filtering includes a first screen of false positives by eliminating the points which are separated from the sensor means by more than a certain distance.

9. The method according to claim 8, wherein the filtering further comprises a mathematical filter adapted to determine points which identify a correct shape of said motor vehicle.

10. The method according to claim 9, wherein said mathematical filter comprises a data processing operation based on a mathematical spline function; said mathematical spline function being an interpolation having a purpose of interpolating a set of points, corresponding to nodes of the mathematical spline function, over a given range in such a way that the interpolation is continuous at each point of the given range up to at least a given order of derivatives.

11. The method according to claim 6, wherein the processing is carried out to allow the shape of the motor vehicle and the paths followed by the movable washing means during the washing step to be determined once the false positives have been eliminated.

12. The method according to claim 6, wherein paths of the movable washing means are calculated by dividing each surface of the motor vehicle into sectors equal in size and shape to each other, and performing a spline-based mathematical operation on each sector to determine a central point for each sector.

13. The method according to claim 12, wherein a path to be followed by the movable washing means can be established with use of central points.

14. A computer comprising a computer program implementing the method according to claim 6.
